(19) United States
(12) Patent Application Publication
(10) Pub. No.: US 2026/0337896 A1
(43) Pub. Date: Oct. 29, 2026

(54) Geocomposite

(71) Applicant: Tensar International Corporation, Alpharetta, GA (US)

(72) Inventors: Manoj Kumar Tyagi, Alpharetta, GA (US); Jeffrey Rasche, Alpharetta, GA (US); Tommy James, Alpharetta, GA (US)

(73) Assignee: Tensar International Corporation, Alpharetta, GA (US)

(21) Appl. No.: 19/401,994

(22) Filed: Nov. 26, 2025

(30) Foreign Application Priority Data
Mar. 18, 2025 (GB) 2503961.1

(51) Int. Cl. E01C 7/32; B32B 5/02; B32B 5/26; B32B 7/12; E01C 19/48

(52) U.S. Cl. CPC E01C 7/325; B32B 5/022; B32B 5/028; B32B 5/275; B32B 7/12; E01C 19/48; B32B 2255/02; B32B 2255/26; B32B 2262/101; B32B 2307/54; B32B 2307/718

(57) ABSTRACT

The present invention relates to a geocomposite comprising two layers of geotextile and a mesh disposed therebetween, the mesh formed from fibers, such as glass fibers, wherein the fibers, such as glass fibers, have a polymeric coating, as well as to methods of producing such geocomposites, asphalt pavements incorporating said geocomposites, and methods of constructing such asphalt pavements.

The present invention relates to a geocomposite suitable for use in asphalt pavements, particularly for their reinforcement, for example as an interlayer, as well as methods of producing said geocomposite, asphalt pavements comprising said geocomposites, and methods of using said geocomposites.

### CROSS REFERENCE TO RELATED APPLICATIONS

This application is a U.S. Nonprovisional Utility Patent Application Under 35 USC 111(a) claiming the benefit of United Kingdom Patent Application No. 2503961.1 filed Mar. 18, 2025 which is incorporated herein by reference in its entirety.

### BACKGROUND

Asphalt interlayers are often used in the construction of asphalt pavements to improve the qualities of the resulting asphalt pavement (e.g. resistance to cracking, resistance to water ingress, improved slip resistance, and fatigue improvement). The interlayers are installed below the surface course, either directly or below a sublayer. Many materials have been used for these applications, such as basalt fibers, carbon fibers, glass fibers or geotextiles. Some interlayers comprise bare fibers, such as glass fibers. These have the required material properties to improve the asphalt pavement, but tend to suffer from breakage of the fibers on unrolling. To improve handleability, the fibers are often mounted on (e.g. stitched to) or otherwise embedded within a geotextile layer, which protects the fibers during unrolling.

Existing interlayers have a tendency to form wrinkles and ridges as they are lain. To limit the formation of these raised areas, installation must be undertaken slowly. After the initial installation step, the deformations must be found by visual inspection and removed manually by brooming, walking, or slitting. If this is not done, these raised areas are detrimental to the performance of the resulting asphalt pavement. If rectified by slitting, the slits represent a point of weakness within the asphalt pavement. Accordingly, although the benefits of including interlayers in asphalt pavements are clear, effectively laying the interlayers to obtain these benefits is a slow, labour-intensive process. In addition, it is desirable to further improve the tensile strength of the interlayer.

It is the object of the present invention to address one or more of the foregoing issues.

### SUMMARY OF THE INVENTION

A first aspect of the present invention relates to a geocomposite comprising two layers of geotextile and a mesh disposed therebetween, the mesh formed from fibers, such as glass fibers, wherein the fibers, such as glass fibers, have a polymeric coating.

The mesh may be formed from woven fibers, knitted fibers, or laid-scrim fibers, such as woven glass fiber, knitted glass fiber, or laid-scrim glass fiber. The mesh may have substantially quadrilateral apertures, such as substantially rectangular or square apertures. The quadrilateral apertures may have dimensions of from 5 to 50 mm, preferably from 6 to 25 mm, more preferably from 6 to 12.5 mm.

The polymeric coating may comprise polyacrylates.

The mesh may have tensile strength of from 25 to 400 kN m⁻¹, preferably from 25 to 200 kN m⁻¹, more preferably from 50 to 150 kN m⁻¹, such as about 100 kN m⁻¹.

The geotextile may be a non-woven fabric. The geotextile may comprise a polyester (such as polyethylene terephthalate (PET) and PET blends) or a polyolefin (such as polypropylene (PP) or PP blends). The geotextile may have a basis weight of from 10 to 200 gsm, preferably from 15 to 140 μm, more preferably from 15 to 40 gsm. The geotextile may be free of coatings, such as polymeric coatings.

The mesh may be affixed to one or more of the layers of geotextile, for example by stitching, adhesives or lamination.

A second aspect of the present invention relates to a method of producing a geocomposite, the method comprising: disposing a mesh comprising fibers, such as glass fibers, between two layers of geotextile, the fibers, such as glass fibers, having a polymeric coating; and affixing a first layer of geotextile to one or both of the second layer of geotextile and the mesh.

The mesh may be provided by weaving or knitting fiber, such as glass fiber, or by providing the fibers, such as glass fiber, as laid scrim.

The method may further comprise the step of applying the polymeric coating to the fibers, such as glass fibers, preferably by spray coating.

Affixing may be achieved using adhesives, preferably by adhesion of the first layer of geotextile, the mesh, and the second layer of the geotextile.

The geocomposite produced by the method of the second aspect of the present invention may be a geocomposite as described in the first aspect of the present invention.

A third aspect of the present invention relates to an asphalt pavement comprising: a substrate;

an asphalt course comprising aggregate and a binder; and the geocomposite as described in the first aspect of the present invention disposed between the substrate and the asphalt course.

The geocomposite may be substantially free of raised areas and/or slits.

The asphalt pavement may further comprise a tack coat disposed between the substrate and the geocomposite. The substrate may be an asphalt. The asphalt course may have a thickness of from 30 to 300 mm. The binder may be bitumen. The aggregate may have an average particle size of from 5 to 35 mm.

A fourth aspect of the present invention relates to a method of constructing an asphalt pavement, the method comprising: installing the geocomposite as described in the first aspect of the present invention on a substrate; disposing a course of asphalt over the installed geocomposite, the asphalt comprising a binder and an aggregate; compacting the asphalt; and setting the binder.

The installed geocomposite may be substantially free of raised areas and/or slits.

The substrate may be an asphalt. The method may further comprise the step of applying a tack coat to the substrate prior to installing the geocomposite, optionally wherein the tack coat is a bitumen. The asphalt course may have a thickness of from 30 to 300 mm. The binder may be bitumen. The aggregate may have an average particle size of from 5 to 35 mm.

Setting the binder may comprises allowing the binder to cool, allowing any solvents, if present, to evaporate, or a combination thereof.

### BRIEF DESCRIPTION OF THE DRAWINGS

FIGS. 1A and 1B show the top and bottom faces of the geocomposite (100) of the present invention. The geocomposite (100) comprises a mesh (110) formed of glass fiber with a polymeric coating disposed between two layers of geotextile (120). The two layers of the geotextile (120) are white and translucent, allowing the mesh (110) to be observed as a black grid.

FIG. 2 shows a schematic cross-section of the geocomposite (100) of the present invention. The geocomposite (100) comprises a mesh (110) formed of fiber, such as glass fiber, with a polymeric coating disposed between two layers of geotextile (120).

FIG. 3 shows schematic cross-sections of the beams subjected to four point bending beam testing. The left-hand cross-section comprising the geocomposite of the present invention and the right-hand cross-section being absent of an interlayer.

FIG. 4 shows a schematic cross-section of the four point bending beam test apparatus.

FIG. 5 shows a plot of the extrapolated increase in fatigue life for the samples having comparative interlayers and inventive geocomposites compared to a control. It can be seen that the inventive geocomposites had better performance than the interlayers with the same strength of glass fiber.

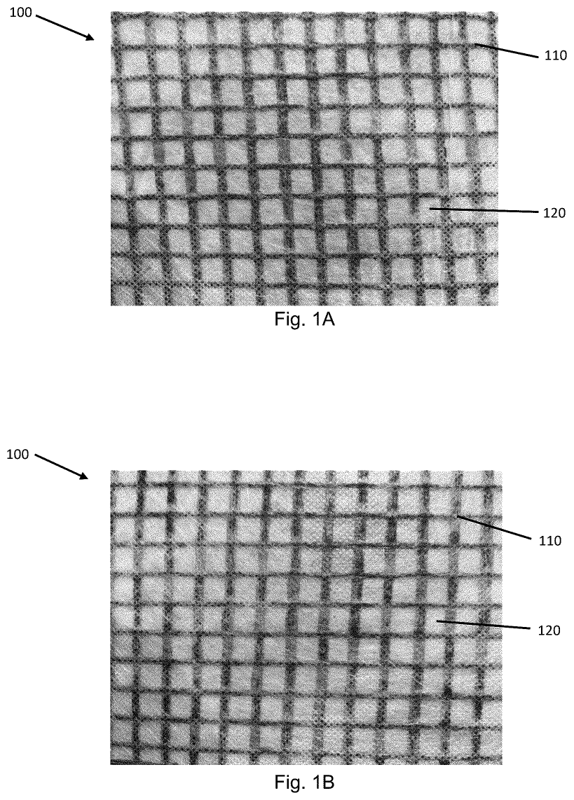

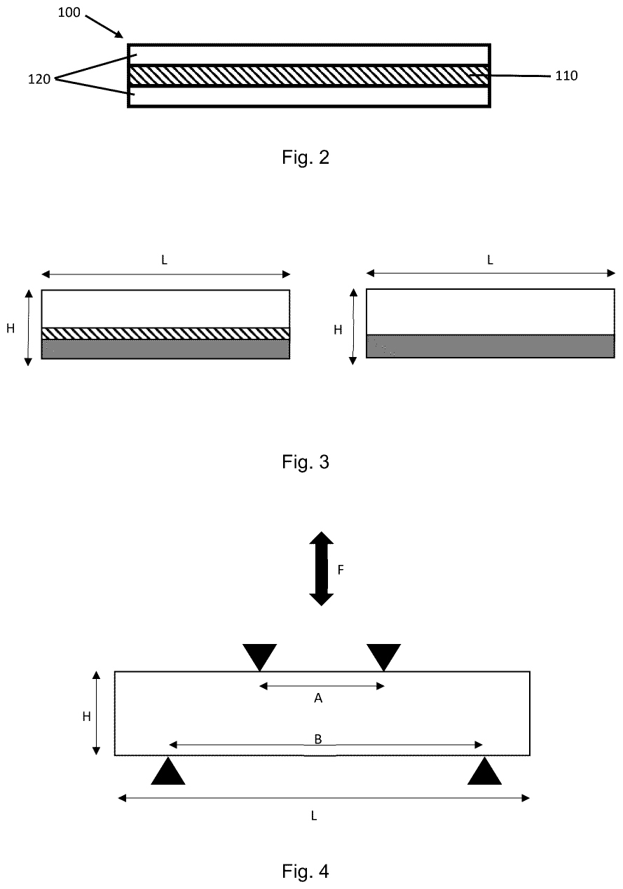

### DETAILED DESCRIPTION

A first aspect of the present invention relates to a geocomposite comprising two layers of geotextile with a mesh disposed therebetween, the mesh being formed of fibers, such as glass fibers, wherein the fibers, such as glass fibers, have a polymeric coating. By being disposed between the two layers of geotextile, the mesh is to an extent protected from forces applied during installation of the geocomposite that may otherwise damage the fibers, such as glass fibers, from which the mesh is formed. This protection is enhanced by the presence of the polymeric coating. This arrangement of materials provides a handleable geocomposite with sufficient tensile strength to achieve high performance as an asphalt interlayer, while avoiding problems with raised areas (such as wrinkles) developing during the installation process. Without wishing to be bound by theory, it is thought that the stiffness of the geocomposite is increased in the plane defined by the geotextile, thereby reducing, or eliminating, incidence of areas lying out of plane (i.e. raised areas). In embodiments, the incidence of observable wrinkles, when the geocomposite is laid on a milled asphalt surface at a span of 75 m, is less than 80 per 304 m (1000 feet), preferably less than 50 per 304 m (1000 feet), more preferably less than 30 per 304 m (1000 feet), further preferably less than 10 per 304 m (1000 feet), most preferably about 0 per 304 m (1000 feet).

The mesh is formed of fibers. The fibers are those having a high stiffness, with suitable fibers being selected from glass fibers, basalt fibers, carbon fibers, and combinations thereof. In preferred embodiments, the mesh is formed from glass fibers. This may mean that the mesh is comprised of the fibers, such as glass fibers, and further elements that allow them to retain the mesh configuration. Alternatively, the mesh may consist, or consist essentially of, the fibers, such as glass fibers. In embodiments, the fibers are provided as woven fibers, knitted fibers, or laid scrim. In particular embodiments, the glass fibers are provided as woven glass fibers, knitted glass fibers, or laid scrim glass fibers.

By “mesh” or “mesh configuration”, it is meant that the fibers, such as glass fibers, are arranged such that they form a planar, reticulated net with regular, repeated apertures between strands or bundles of the fibers, such as glass fibers. The apertures may be substantially any shape. By having apertures that aggregate may, either entirely or partially, enter into, interaction between the aggregate (and hence the asphalt comprising the aggregate) and the geocomposite is enhanced. Preferably, the apertures are substantially quadrilateral in shape, as such arrangements are more easily manufactured and have tensile strength in both the machine direction and cross direction. Quadrilateral apertures may be substantially rectangular or substantially square. The quadrilateral apertures may have any suitable dimensions. For example, the sides of the apertures may have a length of from 5 to 50 mm, preferably from 6 to 25 mm, more preferably from 6 to 12.5 mm.

The fibers, such as glass fibers, have a polymeric coating. Preferably, the polymeric coating comprises a polyacrylate. Any suitable polyacrylate may be used. Preferably, the polymeric coating covers substantially the entire surface of the fibers, such as glass fibers. The fibers, such as glass fibers, and polymeric coating may be present in a weight ratio of from 10:1 to 3:1, preferably from 8:1 to 3.5:1, more preferably from 6:1 to 4:1.

The coating limits the relative mobility of the fibers, such as glass fibers, ensuring that the mesh retains its structure. The coating also increases the stiffness of the mesh. The higher stiffness increases the planarity of the geocomposite, making it easier for the geocomposite to lie flat without wrinkling. The coating also modifies the surface properties of the fibers, such as glass fibers, improving interaction with the bitumen from the asphalt and increasing the geocomposite's resistance to moisture. In preferred embodiments, the individual fibers are coated (i.e. the fibers are provided with the polymeric coating prior to their formation into the mesh). This provides the fibers with the protective benefits of the polymeric coating, while preventing an unsuitably high increase in stiffness in the resulting mesh that allows the geocomposite to conform, to a degree, to unevenness in the underlying substrate.

The mesh has a tensile strength sufficient to allow reinforcement of the asphalt pavement in which it is embedded. For example, the mesh may have a tensile strength of from 25 to 400 kN m⁻¹, preferably from 25 to 200 kN m⁻¹, more preferably from 50 to 120 kN m⁻¹, such as about 100 kN m⁻¹. Tensile strength may be determined as set out in ASTM D 6637M-15(2023).

Any suitable geotextile material may be used. It will be understood that geotextiles are distinct from meshes, as used herein, in that they do not have openings that aggregate, or other solids, may partially, or totally, enter into. Preferably the geotextile is a non-woven fabric as such materials are advantageously porous, allowing for higher uptake of, and interaction with, binder materials from the asphalt and, if used, tack coat. This greater uptake and adsorption improves interaction with the asphalt pavement and increases the geocomposite's ability as a moisture barrier. The geotextile may comprise a polyester (such as polyethylene terephthalate (PET) and PET blends) or a polyolefin (such as polypropylene (PP) or PP blends). These materials have strong interaction with binder materials from the asphalt. Preferably, the geotextile comprises PET.

The geotextile may have a basis weight of from 10 to 200 gsm, preferably from 15 to 140 gsm, more preferably from 15 to 40 gsm.

Preferably, the geotextile is white in color. The geotextile being white in colour improves the rate at which the surface to which the geocomposite is applied cools, thereby reducing the time before which the geocomposite is sufficiently adhered to the surface to allow for the laying of the asphalt pavement onto it. It will be understood that the separation of the two layers of geotextile by the mesh allows the upper layer (i.e. that not in contact with the underlying surface) to remain white in use, while the lower layer is still able to make good contact with the underlying surface and any tack coat applied thereto (which discolors the geotextile). Without wishing to be bound by theory, the color being white increases the rate at which the geocomposite radiates heat and reduces solar gain. In embodiments, the reduction in temperature is between 5 and 10% compared to prior art black interlayers.

The arrangement of the geotextile layers and mesh provides a geocomposite with a number of further advantages. The geocomposite is durable, but remains easily cut with handheld tools, such as scissors, allowing the geocomposite to be cut around obstacles, such as ironworks (e.g. manhole covers and grates). The geocomposite is durable and chemically stable, ensuring that it will remain effective for the lifetime of the asphalt pavement. In addition, the geocomposite has excellent milling performance, allowing the asphalt pavement to be recycled by milling at the end of life.

The mesh may be affixed to one or more of the layers of geotextile. Being affixed ensures that the arrangement is robustly retained during transportation and installation of the geocomposite. The mesh may be affixed by any suitable means, for example by stitching, adhesives or laminated. Additionally, or alternatively, the layers of the geotextile may be mutually affixed to one another. In embodiments where the mesh is not affixed to either of the layers of geotextile, such mutual affixing of the geotextile layers may affix the position of the mesh by the formation of pockets where the two layers of geotextile are not mutually affixed due to the presence of the mesh preventing direct contact between the two layers of geotextile. In embodiments where the mesh is affixed to either of the layers of geotextile, such mutual affixing of the geotextile layers further assures retention of the desired arrangement of the geocomposite. The two geotextile layers may be mutually affixed by any suitable means, for example by stitching, adhesives, or thermal means (such as thermolamination or ultrasonic welding). In a preferred embodiment, the two layers of the geotextile and the mesh are adhered together. It will be understood that the polymeric coating present on the fibers, such as glass fibers, advantageously improves the strength of attachment. Geotextiles in these applications are often provided with coatings, either intentionally or as a byproduct of affixing the mesh. Preferably, the geotextile is substantially free of coatings, such as adhesive coatings or polymeric coatings. Without wishing to be bound by theory, it is thought that the presence of a coating on the geotextile increases its rigidity and lowers its ability to interact with bitumen or, if present, a tack coat, which results in poorer laying properties.

The geocomposite may have any suitable width, matched to the intended width of the asphalt pavement. The width of the geocomposite may be from 1 to 5 m, preferably from 1.5 to 4.5 m. In exemplary embodiments, the geocomposite has a width of 1.5 m, 3 m, or 3.8 m.

The geocomposite is preferably provided in the form of a roll to allow for transportation. In use, the geocomposite is unwound from the roll and then applied to the substrate on which the asphalt course is to be formed.

A second aspect of the present invention relates to a method of producing a geocomposite, the method comprising disposing a mesh comprising fibers, such as glass fibers, wherein the fibers, such as glass fiber, has a polymeric coating, between two layers of geotextile; and affixing a first layer of geotextile to one or both of the other layer of geotextile and the mesh. The resulting geocomposite may be a geocomposite as described in the first aspect of the present invention.

The mesh may be provided by any suitable means of arranging the fibers, such as glass fibers, into the suitable arrangement. Preferably, the mesh is provided by weaving or knitting fibers, such as glass fibers, into the mesh arrangement, or by providing the fibers, such as glass fibers, as laid scrim. The methods provide a more stable and rigid mesh compared to other fiber laying means. For example, fibers, such as glass fibers, that are simply lain (e.g. in the machine direction and cross-direction) without the affixation provided by weaving, knitting, or laid-scrim techniques can more easily move relative to one another, resulting in a weaker mesh with lower uniformity in aperture size.

The method may comprise the step of coating the fibers, such as glass fibers. In embodiments, the coating step is applied to the fibers, such as glass fibers, before they are formed into the mesh. Preferably, the coating step is applied to the fibers, such as glass fibers, after they are formed into the mesh. The fibers, such as glass fibers, may be coated using any suitable process, such as dip coating, brushing, or spraying a solution of the coating material. The applied coating material may be allowed to dry naturally or accelerated using heat and/or forced air. For example, the applied coating material may be dried using infrared heating.

Affixing the first layer of the geotextile to one or both of the other layer of the geotextile and the mesh may be achieved by any suitable means, such as stitching, adhesives, or thermal means (e.g. thermolamination or ultrasonic welding). Ensuring a secure attachment between the geotextile and mesh ensures that there is no separation of the layers during installation of the geocomposite. Preferably, affixation is achieved by adhesives. In a preferred embodiment, the first layer of the geotextile, the mesh, and the second layer of the geotextile are adhered together using adhesives. In a particular embodiment, adhesive is applied to each face of the mesh and one of the geotextile layers is pressed to each face. Curing of the adhesive may be accelerated using heat.

Between each stage of manufacture, the intermediate product (e.g. mesh comprising fibers, such as glass fiber, or mesh comprising coated fibers, such as coated glass fiber) may be stored on a roll. Alternatively, the steps of the method may lead directly into one another. In one example, the mesh is formed and the fibers, such as glass fibers, coated, with the mesh comprising coated fibers, such as coated glass fiber, being wound onto a roll. In another example, the mesh is formed, the fibers, such as glass fibers, coated, and the geotextile affixed before the completed geotextile is wound onto a roll.

A third aspect of the present invention relates to an asphalt pavement comprising a substrate; an asphalt course comprising aggregate and a binder; and the geocomposite as described in the first aspect of the present invention disposed between the substrate and the asphalt course.

The geocomposite may be substantially free of raised areas and/or slits. In embodiments, the incidence of observable wrinkles, when the geocomposite is laid on a milled asphalt surface at a span of 75 m, is less than 80 per 304 m (1000 feet), preferably less than 50 per 304 m (1000 feet), more preferably less than 30 per 304 m (1000 feet), further preferably less than 10 per 304 m (1000 feet), most preferably about 0 per 304 m (1000 feet). The presence of raised areas, and slits formed when rectifying such areas, result in poorer properties for the asphalt pavement.

The asphalt pavement may further comprise a tack coat. The tack coat is disposed between the substrate and the geocomposite and enhances contact and adhesion between them. This aids the geocomposite in lying flat to the surface and tolerating trafficking before deposition of the asphalt course. The tack coat also increases the shear strength of the interface between the substrate and geocomposite. Tack coatings may be bitumens or bitumen emulsions. Typically, the bitumen emulsion comprises bitumen as the binder, but it may comprise polymer modified bitumen.

The substrate may be any substantially planar surface. Preferably the substrate is a solid mass such as a concrete or an asphalt. The asphalt may be newly laid, pre-existing, or milled. Preferably, the substrate is clean and dry prior to installation of the geocomposite.

It will be understood that references to the asphalt course are references to the asphalt layer deposited over the geocomposite. Any suitable thickness may be selected, depending on the intended application of the asphalt course. The asphalt course may have a thickness of from 300 mm to 30 mm, with a thicker layer of asphalt course being required to support a heavier load. Preferably, the thickness of the aggregate course will be 250 mm to 30 mm, more preferably 200 mm to 30 mm, yet more preferably 150 to 30 mm, most preferably 100 mm to 37.5 mm.

Any suitable binder may be used for the asphalt course. Typically, the binder is a bitumen. The bitumen may be a hot or cold applied bitumen.

Any suitable particulate matter may be used as the aggregate. The particle size of the aggregate is typically in the range of 5 to 35 mm, preferably 10 to 32 mm. Alternatively, the particle size of the aggregate may be up to 11 mm, up to 16 mm, up to 22 mm, or up to 32 mm. Aggregate particle size may be determined by sieving, for example, in accordance with BS EN 933-1:2012.

The asphalt course may further comprise recycled asphalt, additional binders, or fillers.

A fourth aspect of the present invention relates to a method of constructing an asphalt pavement, the method comprising installing the geocomposite as described in the first aspect of the present invention on a substrate; disposing a course of asphalt over the installed geocomposite, the asphalt course comprising aggregate and a binder, compacting the asphalt, and setting the binder.

Installing the geocomposite may comprise unwinding the geocomposite from a roll as the roll advances along the substrate, the rate of unwinding the roll and the rate of advancement of the roll being matched such that the unwound geocomposite remains under sufficient tension to avoid wrinkling. In embodiments, the geocomposite is pushed against the substrate at the point the unwound geocomposite contacts the substrate, for example, with a roller or a brush. Preferably, the installation process is performed using suitable mechanical means, such as a tractor, to provide consistent tension and uniformity in the application of the geocomposite onto the substrate or, if present, into the tack coat.

Preferably, the installed geocomposite is substantially free of raised areas and/or slits. In embodiments, the incidence of observable wrinkles, when the geocomposite is laid on a milled asphalt surface at a span of 75 m, is less than 80 per 304 m (1000 feet), preferably less than 50 per 304 m (1000 feet), more preferably less than 30 per 304 m (1000 feet), further preferably less than 10 per 304 m (1000 feet), most preferably about 0 per 304 m (1000 feet). The installed geocomposite is substantially free of these defects. Without wishing to be bound by theory, it is thought that the high in-plane stiffness reduces, or eliminates, the incidence of raised areas, thereby reducing, or eliminating, the need to introduce slits to address such raised areas.

The substrate may be any substantially planar surface. Preferably the substrate is a solid mass such as a concrete or an asphalt. The asphalt may be newly laid, pre-existing, or milled. Preferably, the substrate is clean and dry prior to installation of the geocomposite.

The asphalt course may have a thickness of from 300 mm to 30 mm, with a thicker layer of asphalt course being required to support a heavier load. Preferably, the thickness of the aggregate course will be 250 mm to 30 mm, more preferably 200 mm to 30 mm, yet more preferably 150 to 30 mm, most preferably 100 mm to 37.5 mm.

Any suitable binder may be used for the asphalt course. Typically, the binder is a bitumen. The bitumen may be a hot or cold applied bitumen.

Any suitable particulate matter may be used as the aggregate. The particle size of the aggregate is typically in the range of 5 to 35 mm, preferably 10 to 32 mm. Alternatively, the particle size of the aggregate may be up to 11 mm, up to 16 mm, up to 22 mm, or up to 32 mm. Aggregate particle size may be determined by sieving, for example, in accordance with BS EN 933-1:2012.

The asphalt course may further comprise recycled asphalt, additional binders, or fillers.

The method may further comprise applying a tack coat to the substrate prior to installing the geocomposite. The tack coat also increases the shear strength of the interface between the substrate and geocomposite. Tack coatings may be bitumens or bitumen emulsions. Typically, the bitumen emulsion comprises bitumen as the binder, but it may comprise polymer modified bitumen.

The method may include a cooling period to allow the tack coat to reach a temperature suitable for the laying of the asphalt. At higher temperatures, the tack coat lacks sufficient viscosity and adhesion to prevent movement of the geotextile. Preferably, the geotextile is white in color. It will be understood that the separation of the two layers of geotextile by the mesh allows the upper layer (i.e. that not in contact with the underlying surface) to remain white in use, while the lower layer is still able to make good contact with the underlying surface and any tack coat applied thereto (which discolors the geotextile). Without wishing to be bound by theory, the color being white increases the rate at which the geocomposite radiates heat and reduces solar gain. In embodiments, the reduction in temperature is between 5 and 10% compared to prior art black interlayers.

The compaction of the disposed course of asphalt is done prior to the setting of the binder. In some contexts, compaction may not be required. Compaction can be achieved through any suitable means, for example, by vibration and/or application of pressure.

The setting of the binder is when the binder solidifies and forms a matrix within which the aggregate is immobilised, in turn solidifying the asphalt course. Depending on the nature of the binder, setting may occur due to cooling of the binder (i.e. freezing), evaporation of solvent from the binder, or a combination thereof.

### EXAMPLES

### Overlay Testing

Exemplary geocomposites were incorporated into a test asphalt pavement and subjected to overlay testing according to Tex-248-F (2013). The asphalt pavement composition comprised a 12.5 mm nominal maximum aggregate size (NMAS) granitic material with a bitumen binder (PG 76-22 based binder) and 20% reclaimed asphalt pavement (RAP). An air void content of 7% was targeted. Firstly, an asphalt course with a thickness of 50.8 mm was compacted and allowed to cool. A tack coat (PG 67-22) was then hot applied and the geocomposite placed. Once secured, a second asphalt course with a thickness of 50.8 mm was applied and compacted over the geocomposite. The specimens had a thickness of 101.6 mm, which was reduced to a thickness of 62.5 mm for testing with 25 mm below the geocomposite and 37.5 mm above the geocomposite. A 12.5 mm notch was cut into the base of the specimen to simulate an underlayer crack. The specimen was painted white to enable the following of crack propagation.

In the overlay testing method, the specimen was stretched by 0.6 mm and then reverted to its original length. This cycle was performed over a 10 s period and repeated until failure of the specimen (considered to occur when the sample has lost 93% of its peak strength) or until 1000 cycles have been performed. The number of cycles to failure was recorded. The Crack Propagation Ratio (CPR) was also determined, being a measure of the reduction in load required to propagate cracking. A lower CPR indicates more a more resilient specimen. A control absent of an interlayer was subjected to the same overlay testing. Due to the small sizes of the specimens and the large difference in modulus between the glass fibers and the asphalt, the test was performed at 0 °C.

| | | | Average | |
|---|---|---|---|---|
| | | | Cycles | Aver- |
| | | | to | age |
| | Interlayer Description | Repeats | Failure | CPR |
| Control | None | 5 | 119 | 1.092 |
| Inventive | Exemplary geocomposite | 6 | >1000 | 0.262 |
| Geocom- | comprising a polymeric coated, | | | |
| posite 1 | interwoven glass fiber mesh with | | | |
| | ultimate tensile strength of | | | |
| | 50 kN m⁻¹ laminated | | | |
| | between two layers of | | | |
| | non-woven PET geotextile | | | |
| Inventive | Exemplary geocomposite | 5 | >1000 | 0.263 |
| Geocom- | comprising a polymeric coated, | | | |
| posite 2 | interwoven glass fiber mesh | | | |
| | with a ultimate tensile strength | | | |
| | of 100 kN m⁻¹ laminated | | | |
| | between two layers of | | | |
| | non-woven PET geotextile | | | |
| Comparative | Prior art, coated, woven/knit | 5 | 947 | 0.368 |
| Interlayer 1 | glass fiber mesh with ultimate | | | |
| | tensile strength of 100 | | | |
| | kN m⁻¹ | | | |
| Comparative | Prior art, unwoven glass fiber | 5 | 283 | 0.467 |
| Interlayer 2 | mesh coated on one side and | | | |
| | adhered to a polyester mat with | | | |
| | ultimate tensile strength of | | | |
| | 50 kN m⁻¹, the | | | |
| | adhesive being applied to both | | | |
| | glass fiber and polyester | | | |
| | mat | | | |

The control absent of an interlayer failed relatively quickly and had a high CPR. Prior art interlayers had variable performance, improving over the control to a moderate extent. In contrast, the specimens comprising the geocomposite did not fail even after 1000 cycles and had a low CPR, demonstrating the improvements to strength and resilience imparted by the geocomposite.

### Four Point Bending Beam Test

A four-point bending apparatus was used to determine the energy required for crack initiation and crack propagation in asphalt beams at a temperature of approximately 20 °C. The beams were formed with a 30 mm base course of AC 11 W 35/50 (comprising granitic material with a maximum stone size of 11.2 mm and 4.8 wt % of a 35/50 bitumen) and a 70 mm surface course of AC 16 W35/50 (comprising granodiorite material with a maximum aggregate size of 16.0 mm and 4.8 wt % of a 35/50 bitumen). The geocomposite is located between the base and surface courses. The overall height of the beam (H) is 100 mm and the length of the beam (L) is 850 mm.

A schematic of the testing apparatus is shown in FIG. 3. Static contact points are provided below the beam at a separation of 740 mm (B) and dynamic contact points are provided above the beam at a separation of 247 mm (A). The beam to be tested was inserted into the apparatus, with the centre of the beam being equidistant from each of the static contact points and each of the dynamic contact points.

A static load is applied to achieve a displacement of 50 mm min⁻¹ with the energy required to cause crack initiation and crack propagation being recorded. Two beams incorporating exemplary geocomposites were tested, along with a control beam absent of an interlayer and a beam comprising a prior art interlayer.

| | | | Crack | Crack |
|---|---|---|---|---|
| | | Deflection | Initiation | Propagation |
| | Force | at break | Energy | Energy |
| | (kN) | (mm) | (kN mm) | (kN mm) |
| Control | 5.4 | 5.0 | 20.3 | 53.1 |
| Inventive | 6.2 | 5.8 | 31.4 | 104.7 |
| Geocomposite 1 | | | | |
| Inventive | 6.2 | 9.2 | 43.5 | 110.6 |
| Geocomposite 2 | | | | |
| Comparative | 5.6 | 5.8 | 24.8 | 67.8 |
| Interlayer 2 | | | | |

Incorporation of the exemplary geocomposites increased the crack initiation energy by 55% and 114% compared to the control without an interlayer and by 27% and 75% compared to the prior art interlayer, meaning that the exemplary geocomposites significantly delay the onset of cracking of asphalt pavements. In addition, incorporation of the geocomposites approximately doubles the crack propagation energy (increases of 97% and 108% compared to the control without an interlayer and of 54% and 63% compared to the prior art interlayer), suggesting that, once formed, cracks will take longer to propagate through the asphalt due to the presence of the geocomposite.

### Installation Properties

A test section of asphalt pavement was milled and surface debris cleared. A bitumen binding agent (PG 64-10) was heated and applied to the surface at a rate of 0.18 gallons per square yard (0.81 L m⁻²) to provide a tack coat. Geocomposite 2 and Comparative Interlayer 2 were installed side-by-side to directly compare their installation properties.

Compared to Comparative Interlayer 2, Inventive Geocomposite 2 was faster and easier to unroll and install, and achieved a flatter surface with fewer wrinkles or ridges that would require manually cutting and/or flattening. Inventive Geocomposite 2 also remained flatter and achieved good adhesion to the tack coat. In addition, no damage or delamination was observed when Inventive Geocomposite 2 was trafficked by construction vehicles during subsequent deposition of the asphalt course. An asphalt course was then deposited on Inventive Geocomposite 2 and Comparative Interlayer 2 using conventional techniques. Inventive Geocomposite 2 accepted the asphalt course well and a good, level finish was obtained.

A similar comparison was undertaken using Inventive Geocomposite 1, Inventive Geocomposite 2, and a polypropylene geotextile. Again, it was found that the geotextile needed to be lain slowly and required significant remediation to remove raised areas. In contrast, each of Inventive Geocomposite 1 and Inventive Geocomposite 2 laid easily to achieve a flat surface suitable for receiving the asphalt course. In addition, the geotextile experienced significant ‘bleed through’ of the tack coat that hindered subsequent deposition of the asphalt course.

Overall, the exemplary geocomposites were found to have better installing properties compared to the prior art interlayers (comprising either glass fibers or polypropylene geotextile), making it simpler and faster to construct a high-quality surface finish. Without wishing to be bound by theory, it is believed that the improved installing properties (e.g. reduced incidence of wrinkles and ridges) are attributable to improved interaction with the binder and higher stiffness attributable to the geotextile and the coating on the glass fibers.

### Fatigue Testing

The four-point bending apparatus was used to determine the fatigue life in asphalt beams formed as set out under “Four Point Bending Beam Test” (above). The beams were tested under controlled strain mode at a temperature of approximately 20 °C and frequency of 5 Hz. The beams were subjected to repeated strains of 300, 240, 400, 450, and 500 μstrain until failure (i.e. half of their strength was lost). The number of cycles to failure at each strain was plotted and extrapolated to determine the fatigue life at strains of 70, 100, and 130 μstrain and hence increase in fatigue life relative to the control sample absent of a geocomposite. These lower strains are more relevant to real world conditions, however, due to time constraints it is not practical to determine these empirically.

| | | Estimated Increase in Fatigue Life Relative | | |
|---|---|---|---|---|
| | | to the Control at a Strain of: | | |
| | Interlayer Description | 70 μstrain | 100 μstrain | 130 μstrain |
| Control | None | 1.0 | 1.0 | 1.0 |
| Inventive | Exemplary geocomposite | 18.6 | 13.4 | 10.5 |
| Geocomposite | comprising a polymeric coated, | | | |
| 1 | interwoven glass fiber mesh with | | | |
| | ultimate tensile strength of 50 kN | | | |
| | m⁻¹ laminated between two layers | | | |
| | of non-woven PET geotextile | | | |
| Inventive | Exemplary geocomposite | 31.1 | 18.2 | 12.2 |
| Geocomposite | comprising a polymeric coated, | | | |
| 2 | interwoven glass fiber mesh with a | | | |
| | ultimate tensile strength of 100 kN | | | |
| | m⁻¹ laminated between two layers | | | |
| | of non-woven PET geotextile | | | |
| Comparative | Prior art, coated, woven/knit glass | 30.2 | 16.1 | 10.2 |
| Interlayer 1 | fiber mesh with ultimate tensile | | | |
| | strength of 100 kN m⁻¹ | | | |
| Comparative | Prior art, unwoven glass fiber | 2.8 | 2.8 | 2.8 |
| Interlayer 2 | mesh coated on one side and | | | |
| | adhered to a polyester mat with | | | |
| | ultimate tensile strength of 50 kN | | | |
| | m⁻¹, the adhesive being applied to | | | |
| | both glass fiber and polyester mat | | | |

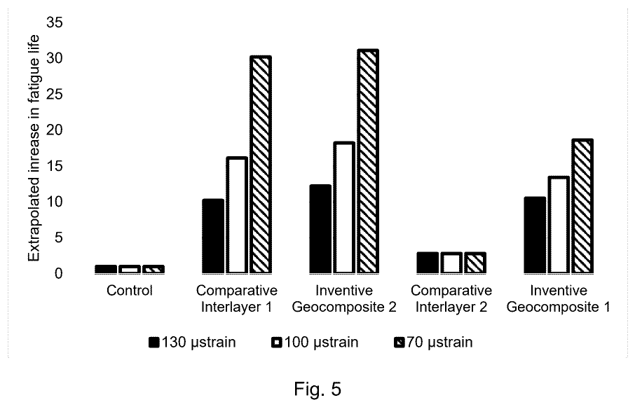

This data is also plotted in FIG. 5, and shows that incorporation of the inventive geocomposite increased the fatigue life of the asphalt beam by a factor of 10 to 31. Significant improvements were also noted over the Comparative Interlayers using glass fibers with the same ultimate tensile strength.

### Estimation of Time Saving

Inventive Geocomposites and Comparative Interlayers were laid side-by-side over a 23-meter (75-foot) span and the number of wrinkles requiring correction was counted for each. No wrinkles requiring correction were observed for the Inventive Geocomposites. Conversely, the Comparative Interlayers had between 80 and 133 wrinkles requiring correction per 304 m (1000 feet).

Accordingly, based on the correction of a wrinkle requiring from 1 to 5 minutes of labor, use of the Inventive Geocomposites provided a time saving of from 80 to 665 minutes of labor per 304 m (1000 feet) of asphalt pavement compared to the Comparative Interlayers. This represents a labor cost saving of from $426 to $3544 per 304 m (1000 feet) of asphalt pavement (based on a crew labor rate of $5.33 per minute). In addition to direct savings of time, this also reduces the overall time required to lay the asphalt pavement, decreasing the time for which the road is unusable by traffic.

The Inventive Geocomposites and Comparative Interlayers are lain onto a hot-melt tack coat. Before the asphalt pavement can be lain, the tack coat is required to cool to a suitable asphalt laying temperature, else its viscosity and adherence are too low, resulting in movement of the Inventive Geocomposites and Comparative Interlayers as they are trafficked during deposition of the asphalt. In addition to the reduction in the incidence of wrinkles, the Inventive Geocomposites were observed to cool to a suitable asphalt laying temperature at a significantly faster rate than the Comparative Interlayers, with the cooling time reduction being estimated as between 5 and 10%.

1. A geocomposite comprising two layers of geotextile and a mesh disposed therebetween, the mesh formed from fibers, such as glass fibers, wherein the fibers, such as glass fibers, have a polymeric coating.

2. The geocomposite of claim 1, wherein the mesh is formed from woven fibers, knitted fibers, or laid-scrim fibers, such as woven glass fiber, knitted glass fiber, or laid-scrim glass fiber.

3. The geocomposite of claim 1, wherein the mesh has substantially quadrilateral apertures, such as substantially rectangular or square apertures.

4. The geocomposite of claim 3, wherein the quadrilateral apertures have dimensions of from 5 to 50 mm, preferably from 6 to 25 mm, more preferably from 6 to 12.5 mm.

5. The geocomposite of claim 1, wherein the polymeric coating comprises polyacrylates.

6. The geocomposite of claim 1, wherein the mesh has tensile strength of from 25 to 400 kN m⁻¹, preferably from 25 to 200 kN m⁻¹, more preferably from 50 to 150 kN m⁻¹, such as about 100 kN m⁻¹.

7. The geocomposite of claim 1, wherein the geotextile:
(i) is a non-woven fabric; and/or
(ii) comprises a polyester (such as polyethylene terephthalate (PET) and PET blends) or a polyolefin (such as polypropylene (PP) or PP blends); and/or
(iii) has a basis weight of from 10 to 200 gsm, preferably from 15 to 140 μm, more preferably from 15 to 40 gsm; and/or
(iv) is substantially free of coatings, such as polymeric coatings.

8. The geocomposite of claim 1, wherein the mesh is affixed to one or more of the layers of geotextile, for example by stitching, adhesives or lamination.

9. A method of producing a geocomposite, the method comprising
disposing a mesh comprising fibers, such as glass fibers, between two layers of geotextile, the fibers, such as glass fibers, having a polymeric coating; and
affixing a first layer of geotextile to one or both of the second layer of geotextile and the mesh.

10. The method of claim 9, wherein the mesh is provided by weaving or knitting fiber, such as glass fiber, or by providing the fibers, such as glass fiber, as laid scrim.

11. The method of claim 9, further comprising the step of applying the polymeric coating to the fibers, such as glass fibers, preferably by spray coating.

12. The method of claim 9, wherein affixing is achieved using adhesives, preferably by adhesion of the first layer of geotextile, the mesh, and the second layer of the geotextile.

13. The method of claim 9, wherein the geocomposite is a geocomposite comprising two layers of geotextile and a mesh disposed therebetween, the mesh formed from fibers, such as glass fibers, wherein the fibers, such as glass fibers, have a polymeric coating.

14. An asphalt pavement comprising:
a substrate;
an asphalt course comprising aggregate and a binder; and
the geocomposite as described in claim 1 disposed between the substrate and the asphalt course.

15. The asphalt pavement of claim 14, wherein the geocomposite is substantially free of raised areas and/or slits.

16. The asphalt pavement of claim 14, wherein:
(i) the asphalt pavement further comprises a tack coat disposed between the substrate and the geocomposite; and/or
(ii) wherein the substrate is an asphalt; and/or
(iii) wherein the asphalt course has a thickness of from 30 to 300 mm; and/or
(iv) wherein the binder is bitumen; and/or
(v) wherein the aggregate has an average particle size of from 5 to 35 mm.

17. A method of constructing an asphalt pavement, the method comprising:
installing the geocomposite as described in claim 1 on a substrate;
disposing a course of asphalt over the installed geocomposite, the asphalt comprising a binder and an aggregate;
compacting the asphalt; and
setting the binder.

18. The method of claim 17, wherein the installed geocomposite is substantially free of raised areas and/or slits.

19. The method of claim 17, wherein:
(i) the substrate is an asphalt; and/or
(ii) the method further comprises the step of applying a tack coat to the substrate prior to installing the geocomposite, optionally wherein the tack coat is a bitumen; and/or
(iii) wherein the asphalt course has a thickness of from 30 to 300 mm; and/or
(iv) wherein the binder is bitumen; and/or
(v) wherein the aggregate has an average particle size of from 5 to 35 mm.

20. The method of claim 17, wherein setting the binder comprises:
(i) allowing the binder to cool; and/or
(ii) allowing any solvents, if present, to evaporate.
